(19) United States
(12) Patent Application Publication
(10) Pub. No.: US 2006/0188132 A1
(43) Pub. Date: Aug. 24, 2006

(54) Image sensor device, living body authentication system using the device, and image acquiring method

(75) Inventor: Kazuyuki Shigeta, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/344,241

(22) Filed: Feb. 1, 2006

(30) Foreign Application Priority Data
Feb. 23, 2005 (JP) 2005-047447

(51) Int. Cl. G06K 9/00

(52) U.S. Cl. 382/115

(57) ABSTRACT

The present invention provides an image sensor device for living body authentication, which achieves both of a high precision and a high authentication speed while reducing costs of the image sensor device and miniaturizing the device. There is provided an inexpensive fingerprint authentication system having a high performance in, for example, a portable terminal. The image sensor device for acquiring image information has an image sensor element, a tone conversion unit having a variable gain amplifier, and a tone conversion characteristic changing unit, and the tone conversion characteristic changing unit is controlled so as to change offset conditions of an image signal and change the tone conversion characteristics during the acquiring of the whole image.

### BACKGROUND OF THE INVENTION

1. Field of the Invention

The present invention relates to an image sensor device and an image acquiring method, more particularly to an image sensor device suitably disposed in a system of living body authentication such as fingerprint authentication or blood vessel authentication, and an image acquiring method.

2. Description of the Related Art

In a living body authentication system using fingerprint, face, iris, palm pattern and the like, an image of a living body is acquired from an image acquiring device, characteristics are extracted from this acquired image, and this information is collated with registered data to identify the living body.

Here, examples of a detection system of the image acquiring device include an optical system using a CCD or CMOS sensor, an electrostatic capacity system, a pressure detection system, a photosensitive system, and an electric field detection system. As another classification, there are systems of a type of acquiring an object image altogether using a two-dimensional area sensor, and a type referred to as a sweep or scan type. In the latter system, successively picked-up images of an object in a sub-scanning direction are synthesized to acquire the whole image by use of a one-dimensional sensor or a band-shaped two-dimensional sensor having about 2 to 20 pixels in the sub-scanning direction.

In the living body authentication system, after the image acquired by the image acquiring device is subjected to various types of image processing such as contrast improvement and edge emphasizing, the characteristics are extracted to perform the collation.

Heretofore, in the contrast improvement processing of the living body authentication system, acquiring conditions are manually adjusted (see Japanese Patent Application Laid-Open No. H08-272953), or the image acquired by the image acquiring device is subjected to calculation processing (see Japanese Patent Application Laid-Open No. H01-158577).

However, in the contrast improvement processing of the conventional living body authentication system, the image is manually adjusted, or the acquired image data is subjected to tone conversion processing which is post-processing. Therefore, there is a problem that the contrast cannot be sufficiently improved in a case where luminance changes largely.

For example, a luminance level largely changes with a change of external light due to an environmental state such as indoor or outdoor light, daylight, or nighttime, or an individual difference of a finger size, transmittance or the like. Especially, when a cellular phone, PDA or the like is provided with the system, an opportunity for use outdoors increases, and the system is largely influenced by such environmental change.

In this case, even when the acquired image is tried to be processed in the post-processing; a tone difference cannot be restored from the acquired image. This is because tone gradation data is already lost in a saturated area or a blackened area of the acquired image

When optimum conditions are tried to be obtained by a manual adjustment operation, a large burden is imposed on a user because the adjustment operation becomes complicated. There is also considered a constitution in which images are picked up a plurality of times to control again exposure conditions by means of an automatic exposure correcting function (AE). However, in a case where the acquired data is saturated or blackened, since there is not any index indicating a degree of required change of the exposure conditions, the data has to be repeatedly acquired many times until appropriate exposure is achieved, and much time is required for convergence.

The tone conversion of the acquired image data by means of image processing indicates that a bit precision of an original image drops. In general, to suppress a data amount, the acquired image cannot be provided with excessively many bits. Therefore, the bit precision becomes very low after the image processing, and an S/N ratio drops.

Such problem becomes remarkable especially in a case where a large difference is made in a luminance distribution in a plane of one living body image. The problem is raised by a luminance difference generated by a positional relation between an optical system to illuminate the object and the object or the like, a luminance difference generated by a transmittance difference in a plane of the object itself and the like.

In a case where there is a large luminance difference in the image acquired at once, even when the acquired image is processed in the post-processing, an optimum value differs with each portion of the plane, and calculation is difficult. Even when the calculation can be executed, the calculation becomes difficult, thereby increasing a calculation time and enlarging a circuit scale. Moreover, in a case where the optical conditions are achieved by the manual operation or the AE, since the optimum conditions differ in the plane, and an adjustable range narrows. When the exposure cannot be adjusted to be optimum, a part of the area of the plane is blackened or saturated. Even in a case where both areas likely be blackened and saturated can be adjusted into a dynamic range, since the dynamic range is adjusted into a broad range, the bit precision after the image processing drops, and the S/N ratio drops.

### SUMMARY OF THE INVENTION

An object of the present invention is to simply and inexpensively realize a high-precision image sensor device having a broad dynamic range corresponding to a luminance difference generated, in a living body image plane, by differences of environmental conditions of a light source and the like, an object shape, and transmittance, a living body authentication system, and an image acquiring method.

The image sensor device of the present invention is a sweeping type image sensor device for authentication, which successively picks up images of partial image information of an object to obtain the whole image of the object. The image sensor device has an image sensor element, tone conversion means, and tone conversion characteristic changing means.

Moreover, in the present invention, the tone conversion characteristic changing means has a constitution capable of changing offset conditions of an image signal so as to change tone conversion characteristics before completing all of tone conversion of the whole image.

Furthermore, the image sensor device of the present invention is characterized by changing the tone conversion characteristics in synchronization with a sub-scanning timing of the image sensor element.

In addition, the image sensor device of the present invention is characterized by detecting a luminance distribution of a living body image to thereby control the tone conversion characteristic changing means.

Consequently, since the broad dynamic range can be secured over the whole image plane, a region becomes broader which can handle changes of environmental conditions such as external light and a shape, a size, and a state of the object, and an image acquiring device having a high detecting capability can be realized.

Moreover, in the image sensor device, the image is acquired while changing the characteristics of the tone conversion in the plane. Therefore, drop of bit precision can be inhibited in preprocessing performed until the characteristics are extracted from the acquired image.

Furthermore, when the tone conversion characteristics in the plane are changed by offset changing means disposed as the tone conversion characteristic changing means in a stage before that of the tone conversion means, a circuit constitution is simplified, and an increase of a circuit scale or a calculation time can be inhibited.

In addition, the tone conversion characteristics can be changed in synchronization with a sub-scanning timing of the image sensor element to thereby simplify a circuit constitution and inhibit the increase of the circuit scale or the calculation time.

Moreover, the luminance distribution of the living body image is detected to thereby control the tone conversion characteristic changing means, thereby optimizing the tone conversion in each portion of one image plane. Therefore, many images do not have to be taken, and an image pickup time can be shortened, and more optimized image can be acquired.

As described above, according to the present invention, an image sensor device for authentication can be realized which has both of a high precision and a high authentication speed while reducing a circuit scale or a calculation amount to thereby achieve cost reduction and miniaturization of the image sensor device. Therefore, there is an effect that it is possible to inexpensively provide, for example, a high-performance fingerprint authentication system in a portable terminal.

### BRIEF DESCRIPTION OF THE DRAWINGS

FIG. 1 is a block diagram showing a constitution of an area type fingerprint authentication device in Embodiment 1 of the present invention;

FIGS. 2A and 2B are an explanatory view of the area type fingerprint authentication device in Embodiment 1 of the present invention;

FIG. 3 is an explanatory view of a CMOS type sensor which is an image sensor element in Embodiment 1;

FIG. 4 is an explanatory view of the CMOS type sensor which is the image sensor element in Embodiment 1;

FIG. 5 is an explanatory view of a tone conversion curve of a tone conversion unit in Embodiment 1;

FIGS. 6A and 6B are an explanatory view showing an operation of Embodiment 1;

FIGS. 7A, 7B, 7C and 7D are an explanatory view showing an operation of Embodiment 1;

FIG. 8 is a flowchart showing a living body image acquiring routine to which the present invention is applied in Embodiment 1;

FIG. 9 is a block diagram showing a constitution of a sweeping type fingerprint authentication device in Embodiment 2 of the present invention;

FIGS. 10A, 10B and 10C are an explanatory view of the sweeping type fingerprint authentication device in Embodiment 2 of the present invention;

FIGS. 11A, 11B and 11C are an explanatory view of the sweeping type fingerprint authentication device in Embodiment 2 of the present invention;

FIGS. 12A and 12B are an explanatory view showing an operation of Embodiment 2;

FIG. 13 is an explanatory view of a tone conversion curve of a PGA section in Embodiment 2;

FIGS. 14A, 14B, 14C and 14D are an explanatory view showing an operation of Embodiment 2; and

FIG. 15 is a flowchart showing a living body image acquiring routine to which the present invention is applied in Embodiment 2.

### DESCRIPTION OF THE PREFERRED EMBODIMENTS

Embodiments of the present invention will be described hereinafter with reference to the drawings.

### First Embodiment

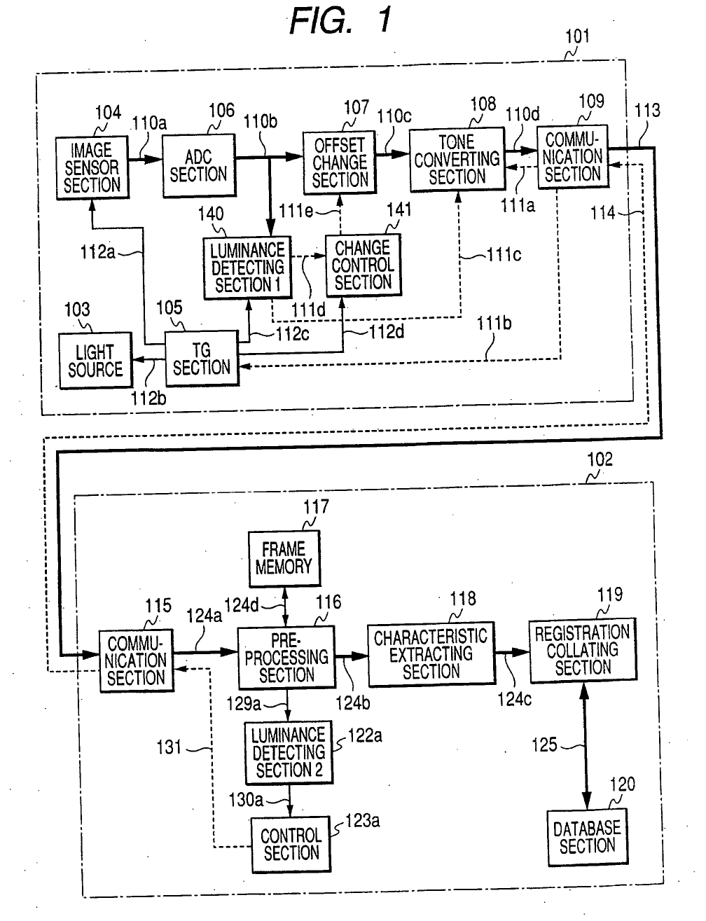

FIG. 1 shows a block diagram of a schematic constitution of an area type fingerprint authentication device to which the present invention is applied as a first embodiment of the present invention. Here, as an example of a large difference of a luminance distribution in a plane of one living body image, there will be described a luminance difference generated by a positional relation between an optical system to illuminate an object and the object. There will be described an example in which environments are detected in the image sensor device, a control coefficient is selected depending on the environments, and one living body image is acquired while controlling offset, thereby improving a dynamic range.

In the present embodiment, the fingerprint authentication device is constituted of an image acquiring unit 101 and an authentication unit 102. The image acquiring unit is, for example, an image sensor unit having an image sensor, and the authentication unit is sometimes a combination of functions executed by a personal computer. Alternatively, the image acquiring unit and the authentication unit are combined as one fingerprint authentication unit to constitute an independent device to be connected to the personal computer (not shown) in some case.

In the image acquiring unit 101 of FIG. 1, reference numeral 103 denotes an LED as a light source (light irradiation means) for illumination.

Reference numeral 104 denotes a CMOS or CCD type image sensor section which is a one-dimensional or two-dimensional sensor. In the present embodiment, the section is the CMOS type two-dimensional sensor having 768 pixels in a main scanning direction and 512 pixels in a sub-scanning direction.

Reference numeral 105 denotes a timing generating (TG) section which controls luminance levels and lighting timings of the image sensor section and the LED, and 106 denotes an AD converter section.

In the present invention, reference numeral 107 denotes an offset change section capable of changing offset during image acquisition, and 108 denotes a tone converting section which subjects, to tone conversion, a signal whose DC component has been changed in a previous stage.

Reference numeral 140 denotes a first luminance detecting section which detects luminance from an image pickup signal 110b to judge environments. Reference numeral 141 denotes a change control section which calculates a change coefficient from this judgment result, and controls the offset change section under control of the timing generating (TG) section.

Moreover, reference numeral 109 denotes a communication section which receives a control signal from the authentication unit, and transmits a data signal to the authentication unit. Reference numeral 113 denotes a data signal line, and 114 denotes a control signal line.

Reference numeral 110a denotes an analog image data signal line, and reference numerals 110b, 110c, and 110d denote digital image data signal lines. Here, the signal is processed with a width of ten bits, and converted from ten bits to eight bits by means of tone conversion between the lines 110b and 110c. The signal line 110d has a width of eight bits.

Reference numerals 111a and 111b denote control lines which receive a control signal of the authentication unit 102 to control the tone converting section and the timing generating (TG) section.

Reference numeral 111c denotes a control line which changes a tone conversion coefficient of the tone converting section 108 from the judgment result of the luminance detecting section. Reference numeral 111d denotes a control line which transmits the judgment result of the luminance detecting section to the change control section 141. Reference numeral 111e denotes a control line via which the change control section 141 controls the offset change section 107.

Reference numerals 112a and 112b denote signal lines of drive pulses transmitted from the timing generating section to the image sensor section and the LED section. Reference numeral 112c denotes a control pulse line of the luminance detecting section, and control is executed so as to initialize the luminance detecting section via the line. Reference numeral 112d denotes a control pulse line to the change control section, and a synchronous signal having a sub-scanning direction is sent via the line to change the offset in synchronization with the signal of the sub-scanning direction.

In the authentication unit 102, reference numeral 115 denotes a communication section.

Reference numeral 122a denotes a second luminance detecting section which distinguishes an area including living body information from acquired image information and which detects the luminance of the distinguished living body information area. Reference numeral 123a denotes a control section which receives information of sections including the second luminance detecting section to control the image acquiring unit 101.

Reference numeral 116 denotes a preprocessing section which performs image processing such as edge emphasizing in order to extract characteristics in a subsequent stage. Reference numeral 117 denotes a frame memory section for performing the image processing. Reference numeral 118 denotes a characteristic extracting section, and 119 denotes a registration collating section which registers individual characteristics extracted by the section 118 in a database or which compares and collates the characteristics with registered data. Reference numeral 120 denotes a database section which stores individual data.

Reference numerals 124a, b, c, and d denote data lines which transmit image data. Reference numeral 125 denotes a data line or a control line between the database section and the registration collating section. Reference numeral 129a denotes a signal line which sends image information required for luminance detection, 130a denotes a signal line which transmits a luminance detection result, and 131 denotes a signal line which receives a state of each section to transmit a signal for controlling the image acquiring unit.

In the present embodiment, the first luminance detecting section 140 judges the environments from the image signal which has been acquired by the image sensor section and AD-converted, and sets a tone conversion coefficient of the tone converting section 108. The change control section 141 determines the coefficient to change the offset in the plane based on the judgment of the first luminance detecting section, and controls the offset change section so as to change an offset control amount in a stepwise manner in accordance with the control pulse which is generated by the TG section 105 and which is synchronized with the scanning in the sub-scanning direction. The coefficient to change the offset in the plane is recorded as a value corresponding to the judgment result of the first luminance detecting section in a lookup table in the change control section 141. As the coefficient to be changed, a value is selected so as to correct a luminance difference generated by a positional relation between the optical system to illuminate an object and the object as described later, and a control value is calculated depending on the position in the sub-scanning direction to control the offset change section.

Consequently, in the image sensor device, an optical environment is detected, a control coefficient can be selected depending on the environment to acquire one living body image while controlling the offset, and the image having an optimum contrast can be acquired over the whole object.

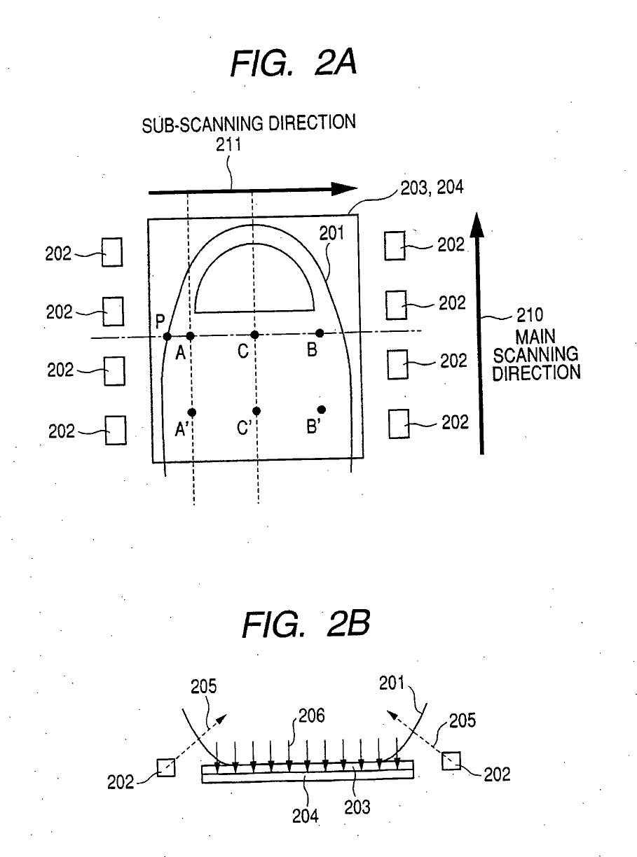

FIGS. 2A to 2B show an explanatory view of an optical fingerprint sensor which is referred to as an area type in the present embodiment and which is capable of acquiring an image of the whole finger by picking up one image and which utilizes scattered light in the finger.

FIG. 2A is a diagram of the finger seen from above, and FIG. 2B is a diagram in a cross-sectional direction of the finger.

Reference numeral 201 denotes the finger, and 202 denotes LEDs as light sources. Reference numeral 203 denotes an optical member which guides an optical difference of an uneven pattern of a fingerprint to a sensor, and 204 denotes a two-dimensional sensor which is a CMOS type image sensor element here.

Here, reference numeral 205 denotes an emission direction of light from the light source to the finger, and 206 denotes an incidence direction of light from the finger to the sensor.

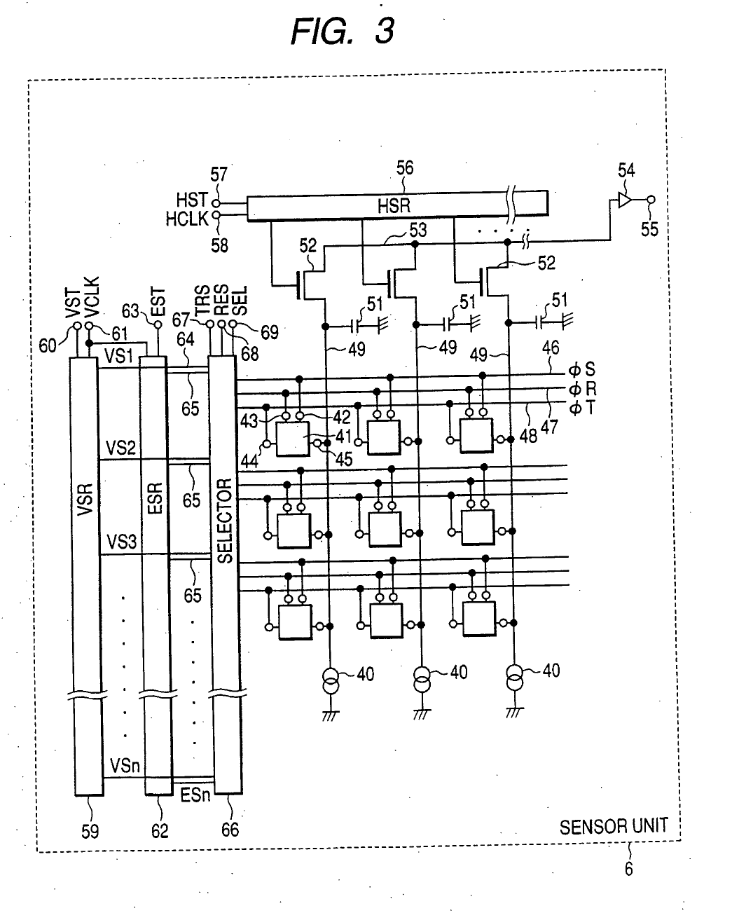

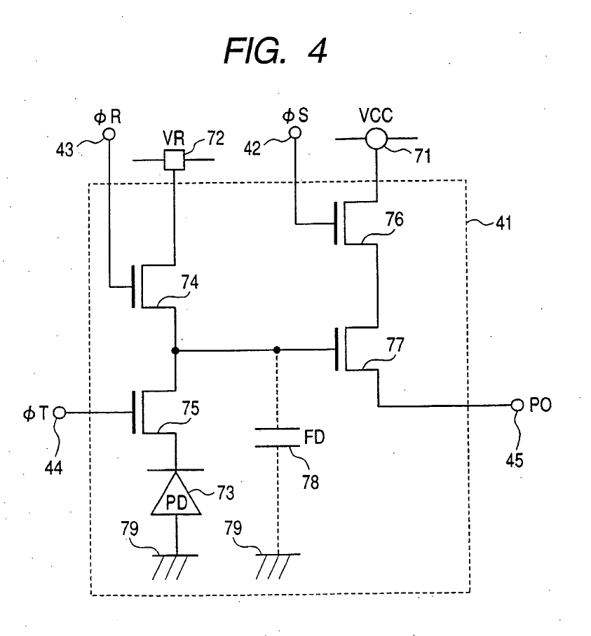

Here, reference numeral 210 denotes a main scanning direction of the sensor, and 211 denotes a sub-scanning direction of the sensor. Here, definitions of the main scanning direction and the sub-scanning direction will be described later in description with reference to FIGS. 3 and 4.

In the present embodiment, the LEDs which are the light sources are arranged in parallel with the main scanning direction. The finger is disposed so that a longitudinal direction of the finger agrees with the main scanning direction as shown.

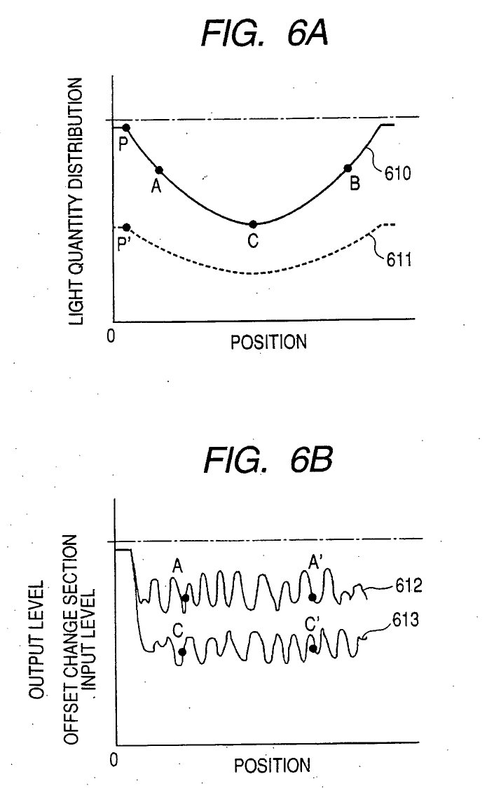

According to such arrangement, it is possible to effectively improve the dynamic range under the control of the offset in the plane as described later in the present invention. Points A, B, C, A′, B′, C′, and P are used in description with reference to FIGS. 6 to 8.

A constitution of the CMOS image sensor section in the present embodiment will be described with reference to FIGS. 3 and 4.

FIG. 3 is a constitution diagram of the image sensor section 104 of FIG. 1. Here, a horizontal scanning direction in a general area sensor corresponds to the main scanning direction, and a vertical scanning direction corresponds to the sub-scanning direction. The usual area sensor first selects one row (e.g., the top row) in a vertical direction, and pixels are successively read from one end toward the opposite end of the row in a horizontal direction (e.g., from a left edge toward the right). Thereafter, the next row in the vertical direction is selected, and similarly the pixels are successively read from one end toward the opposite end of the row in the horizontal direction. The pixels of each row are read in the vertical direction in this manner to acquire the pixels of the whole screen. Therefore, the scanning in the horizontal direction is referred to as main scanning, and the scanning in the vertical direction is referred to as sub-scanning.

Therefore, in the following description of the image sensor section, the main scanning direction has the same meaning as that of the horizontal direction, and the sub-scanning direction has the same meaning as that of the vertical direction.

In FIG. 3, reference numeral 41 denotes a pixel portion constituting one pixel of a sensor, 42 denotes an input terminal of a readout pulse (fS), 43 denotes an input terminal of a reset pulse (fR) of the pixel portion 41, and 44 denotes an input terminal of a transfer pulse (fT) of the pixel portion 41. Furthermore, reference numeral 45 denotes a signal readout terminal (PO) of the pixel portion 41, and 46 denotes a signal line which sends the readout pulse (fS) from a selector section described later to each pixel of the horizontal direction. Furthermore, reference numeral 47 denotes a signal line which sends the reset pulse (fR) from the selector section described later to each pixel of the horizontal direction, 48 denotes a signal line which sends a transfer pulse (fT) from the selector section described later to each pixel of the horizontal direction, 49 denotes a vertical signal line, and 40 denotes a constant current source. Furthermore, reference numeral 51 denotes a capacity connected to the vertical signal line 49, and 52 denotes a transfer switch whose gate is connected to a horizontal shift register 56 and whose source and drain are connected to the vertical signal line 49 and an output signal line 53. Reference numeral 54 denotes an output amplifier connected to the output signal line 53, and 55 denotes an output terminal of a sensor unit 6.

Moreover, reference numeral 56 denotes the horizontal shift register (HSR), 57 denotes an input terminal of a start pulse (HST), and 58 denotes an input terminal of a transfer clock (HCLK). Reference numeral 59 denotes a vertical shift register (VSR), 60 denotes an input terminal of a start pulse (VST), and 61 denotes an input terminal of a transfer clock (VCLK). Furthermore, reference numeral 62 denotes a shift register (ESR) for an electronic shutter of a system referred to as a rolling shutter described later, 63 denotes an input terminal of the start pulse (EST), and 64 denotes an output line of the vertical shift register (VSR). Furthermore, reference numeral 65 denotes an output line of the shift register (ESR) for the electronic shutter, 66 denotes a selector section, 67 denotes an input terminal of an original signal TRS of the transfer pulse, 68 denotes an input terminal of an original signal RES of the reset pulse, and 69 denotes an input terminal of an original signal SEL of the readout pulse.

FIG. 4 is a constitution diagram of the pixel portion 41 of FIG. 3. In FIG. 4, reference numeral 71 denotes a power supply voltage (VCC), 72 denotes a reset voltage (VR), 73 denotes a photo diode, 74 to 77 denote switches constituted of MOS transistors, 78 denotes a parasitic capacity (FD), and 79 denotes ground.

Here, an operation of the image sensor section 104 will be described with reference to FIGS. 3 and 4. First, the reset switch 74 and the switch 75 connected to the photo diode 73 are turned on to reset the parasitic capacity 78. Next, the switch 74 is turned off, and the switch 76 is turned on to thereby read a reset electric charge via the signal readout terminal 45.

Next, the switch 76 is turned off, and the switch 75 is turned on to transfer the electric charges accumulated in the photo diode 73 to the parasitic capacity 78. Next, the switch 75 is turned off, and the switch 76 is turned on to read a signal charge via the signal readout terminal 45.

Drive pulses φS, φR, and φT of MOS transistors are prepared by vertical shift registers 59 and 62 and the selector section 66, and supplied to the pixel input terminals 42 to 44 via the respective signal lines 46 to 48. With respect to one pulse of a clock signal input via the input terminal 60, pulses of signals TRS, RES, and SEL are input into the input terminals 67 to 69, respectively. Therefore, the drive pulses φS, φR, and φT are output in synchronization with the respective signals TRS, RES, and SEL, respectively. As a result, the drive pulses (φS, φR, and φT are supplied to the input terminals 42 to 44.

Moreover, the signal readout terminal 45 is connected to the constant current source 40 via the vertical signal line 49, and connected to the vertical signal line capacity 51 and the transfer switch 52, and the electric charge signal is transferred to the vertical signal line capacity 51 via the vertical signal line 49. Thereafter, the electric charge signal is successively scanned to the transfer switch 52 in accordance with an output of the horizontal shift register 56, the signal of the vertical signal line capacity 51 is successively read via the output signal line 53, and the signal is output from the output terminal 55 via the output amplifier 54. Here, the scanning of the vertical shift register (VSR) 59 is started in response to the start pulse (VST) 60, and the transfer clock (VCLK) 61 is successively transferred to VS1, VS2, . . . VSn via the output line 64. The scanning of the vertical shift register (ESR) 62 for the electronic shutter is started in response to the start pulse (EST) input from the input terminal 63, and the transfer clock (VCLK) input via the input terminal 61 is successively transferred to the output line 65.

As to a readout order of the respective pixel portions 41, one upper row of the vertical direction is first selected, and the pixel portions 41 connected to left to right columns are selected and output in accordance with the scanning of the horizontal shift register 56. After completing the output of the first row, the second row is selected, and the pixel portions 41 connected to the left to right columns are selected and output in accordance with the scanning of the horizontal shift register 56 again.

Thereafter, the first, second, third, fourth, fifth . . . rows are similarly vertically scanned in accordance with the successive scanning of the vertical shift register 59 to output the image for one screen.

In addition, an exposure period of the sensor is determined by an accumulation period for which the image sensor pixel accumulates the electric charges of light, and a period for which the light is emitted from the object to the image sensor pixel.

Here, the CMOS type sensor is not provided with an interrupted buffer memory section unlike an interline transfer (IT) type or frame-interline transfer (FIT) type CCD element. Therefore, the pixel portion 41 from which any signal is not read out yet continues to be exposed even while the obtained signals are successively read out from the pixel portions 41. Therefore, when the screen output is continuously read out, the exposure time becomes substantially equal to the readout time of the screen.

However, in a case where the LED is used as the light source, and the external light is interrupted via an interrupting member or the like, it is possible to regard an only lighting period as an exposure period.

Moreover, as another method of controlling the exposure time, a driving method can be adopted by use of a shutter referred to as a rolling shutter which starts the accumulation in parallel with completion of the accumulation in the vertical scanning. The shutter is used as an electronic shutter (focal plane shutter) in the CMOS type sensor. Accordingly, the exposure time can be set every vertically scanned line in which the accumulation is started and completed in parallel. In FIG. 3, the ESR 62 is a vertical scanning shift register which resets the pixel to start the accumulation, and the VSR 59 is a vertical scanning shift register which transfers the electric charge to complete the accumulation. When an electronic shutter function is used, the ESR 62 is scanned ahead of the VSR 59, and a period corresponding to a scanning interval is an exposure period.

When the accumulation method performed by the rolling shutter is used in the CMOS type area sensor, the pixel electric charges are reset every row in the vertical direction, and the pixel electric charge is read out every row. Therefore, the accumulation can be controlled every row in the vertical scanning direction, that is, the sub-scanning direction.

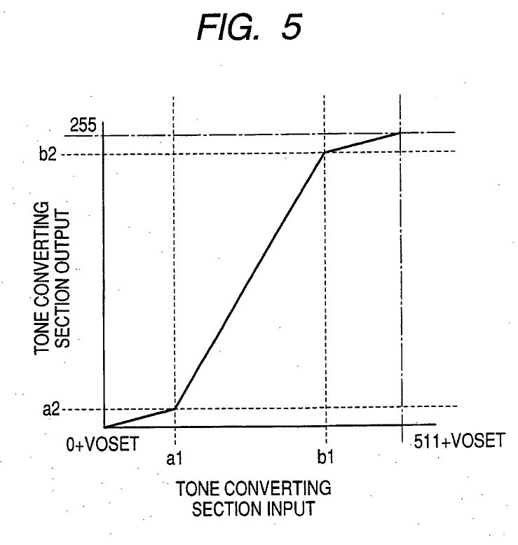

Next, there will be described an operation for controlling tone conversion characteristics in the plane by use of offset control in the present embodiment with reference to FIGS. 5 to 8.

FIG. 5 shows an example of a tone conversion curve for use in the tone converting section. Here, a two-point bending line is shown. Since a characteristic curve is generated from this line graph by means of calculation, there is an advantage that any lookup table that consumes the memory is not required, and a small-scaled circuit is effectively realized. The characteristics can be easily changed by means of the calculation. On the other hand, when the tone conversion curve is prepared using the lookup table, there is an advantage that a higher-precision conversion output is obtained. An optimum characteristic curve is selected in response to a request from the system.

Here, in a range of 0+VOSET to 511+VOSET of inputs added to an offset amount VOSET, the output is converted to values of 0 to 255. A tone conversion gain is high in an area between (a1, a2) and (b1, b2), and an output is obtained by emphasizing input signals which are input into a1 to b1.

FIGS. 6A to 6B show signals obtained in the image sensor device of the present embodiment. In FIG. 6A, the ordinate indicates a luminance distribution of the light emitted into the finger. The abscissa indicates positions of the image sensor element along a straight line connecting point A to point B of FIGS. 2A to 2B in the sub-scanning direction. Reference numeral 610 denotes a light quantity distribution in a case where a light quantity is large (e.g., a case where an ambient light quantity is high or the person's finger has a high transmittance). As shown in FIGS. 2A to 2B, the light is emitted from the LEDs 202 to the sides of the finger 201. Therefore, the luminance of the central point C lowers depending on distances from the points A and B. A light quantity distribution 611 shows a distribution in a case where the light quantity is small (e.g., a case where the ambient light quantity is small or the person's finger has a low transmittance). The luminance of the central point C lowers depending on the distances from the points A and B substantially at substantially the same ratio as that of the distribution 610. Since the light quantity is small, the luminance changes moderately as compared with the distribution 610. A change amount which depends on environments such as the ambient light quantity and the object transmittance can be judged from one typical point. Here, there will be described an example in which the ambient light quantity is determined by means of values P1 and P2 of the point P in FIGS. 2A to 2B which is an outermost portion of the finger in the sub-scanning direction. A curvature of a finger shape differs with individuals, but the positional relation between the finger and the light source is substantially determined. Therefore, a change ratio of the light quantity can be estimated from the detected luminance of the point P in the cross-sectional position of the finger. The offset amount VOSET with respect to the position is calculated using this estimated change ratio a.

FIG. 6B shows signal levels of the image of the finger input into the offset change section. The abscissa indicates the position of the finger in the longitudinal direction (along the straight lines connecting the point A to the point A′ and the point C to the point C′) of FIGS. 2A to 2B, which is the main scanning direction of the image sensor element. Reference numeral 612 denotes the image signal of the finger along the straight line connecting the point A to the point A′, and 613 denotes the image signal of the finger along the straight line connecting the point C to the point C′. A fine uneven portion of the signal indicates a luminance change with a ridge pattern of the fingerprint. When the finger is irradiated in the positional relation of FIGS. 2A to 2B, the luminance difference is generated depending on the positional relation between the object and the light source in the sub-scanning direction, but the luminance difference is not easily generated in the main scanning direction. Therefore, it is seen that when the tone conversion characteristics are changed by changing the offset with respect to the change of the sub-scanning direction, the contrast of the whole image is improved. There is a margin in the calculation time in the sub-scanning direction in which the scanning speed is low rather than the main scanning direction in which the scanning speed is high. Therefore, there is an advantage that the system is easily realized, and the circuit scale and costs can be reduced.

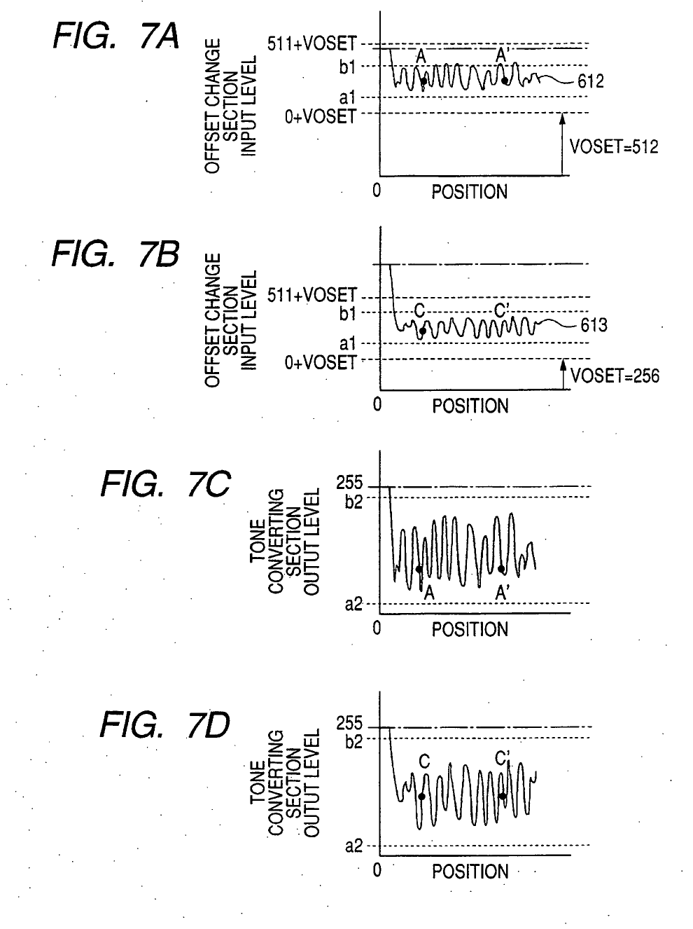

FIGS. 7A and 7B show signals which are input into the offset change section between the points A and A′ and between the points C and C′, respectively. The abscissa indicates positions of the finger in the longitudinal direction, and the ordinate indicates input levels of the offset change section. Here, the input level in the tone converting section at a time when the offset amount VOSET is supplied falls in a range of (0+VOSET to 511+VOSET). FIGS. 7C and 7D show output levels of a tone conversion circuit at a time when the offset amount VOSET is supplied to the input signals between the points A and A′ and between the points C and C′, respectively. The abscissa indicates the positions of the finger in the longitudinal direction, and the ordinate indicates output levels of the tone converting section. The range of (0+VOSET to 511+VOSET) differs with the offset amount VOSET. When as the offset amount VOSET, VOSET=512 is selected between the points A and A′ in FIG. 7A, and VOSET=256 is selected between the point C and C′ in FIG. 7B, the outputs after the tone conversion of the respective signals are converted into a range of a2 to b2. When the offset amount is changed, and the input range into the tone converting section is changed in the image plane in this manner, the dynamic range can be broadened.

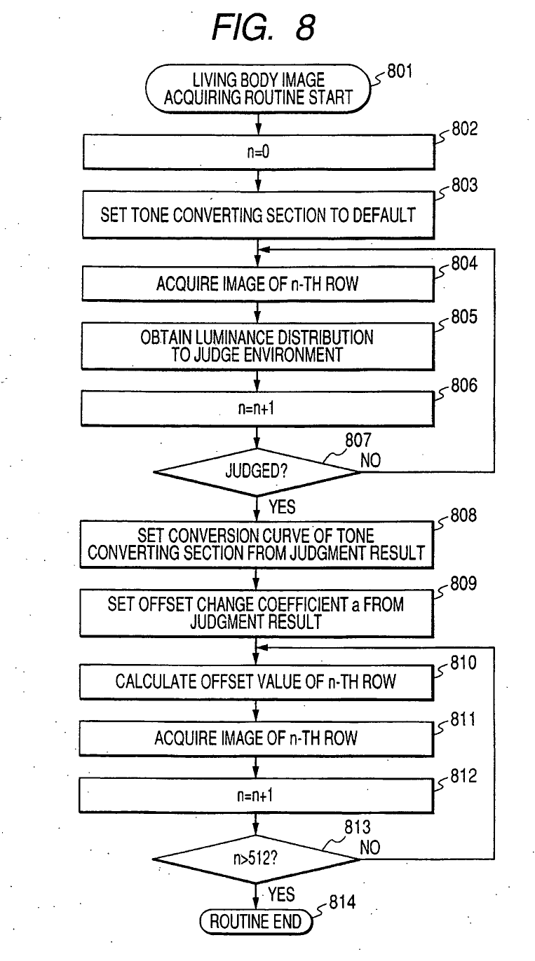

An operation of the image acquiring unit 101 in the present embodiment will be described with reference to a flowchart of FIG. 8. When a routine to acquire a living body image is started under the control of the authentication unit in step 801, a count value is initialized to a value of 9 in the timing control (TG) section in 802. When the first luminance detecting section is initialized by the timing control (TG) section in 803, the first luminance detecting section sets the tone conversion curve of the tone converting section to a default value. An image of one row is acquired in 804, and the luminance distribution included in the signal is obtained by the luminance detecting section in 805 to judge the environments. In 806, the timing control (TG) section increases the counted number of the rows by one. When the environments cannot be judged in the luminance detecting section in 807, the processing returns to 804 to further acquire the image of one row and judge the environments again. When the environments can be judged in 807, the processing advances to 808 to set appropriate conversion characteristics of the tone converting section by the luminance detecting section. In 809, the luminance detecting section similarly sets an appropriate change coefficient for changing the offset. The processing advances to 810 in which the change control section calculates the change amount of the offset of the n-th row to control the offset change section in synchronization with the synchronous signal in the sub-scanning direction from the timing control (TG) section. After the change, the image of the n-th row is acquired in 811. In 812, the timing control (TG) section increase the counted number of the rows by one. In 813, it is judged whether or not the last row is reached (512 rows in this case). When the last row is not reached, the processing returns to 810 to acquire the image of the next row. When the last row is reached, the processing ends.

Consequently, even when the luminance or the contrast of the finger image largely changes with the object shape, size, state change, and environmental change, the tone conversion can be performed appropriately following the change, and a high-quality image can be acquired.

Moreover, the tone conversion is not performed on the side of the authentication device until the image is acquired. Since the image is acquired while executing the tone conversion in the image acquiring device, the bit precision can be inhibited from being lowered in the preprocessing until the characteristics are extracted from the acquired image.

Furthermore, in the constitution of the present invention, the offset amount can be changed in the image plane to easily change the tone conversion characteristics in the image. Therefore, the emphasizing of the contrast of a certain specific portion such as a fingerprint ridge or a blood vessel in picking up the image can be realized with a simple circuit constitution and a small calculation amount. In this case, it is possible to pick up the whole image of the object while inhibiting a blackened or saturated region, and a broad dynamic range is realized.

Moreover, in the present embodiment, there has been described a system in which an object is collated (identified) by means of the fingerprint, but the present embodiment can be similarly used even in the system in which the object is collated (identified) by means of: hand or finger blood vessel; mug such as eye retina, iris, or face lines; hand shape or size and the like.

Furthermore, in the present embodiment, there has been described the image sensor device for living body authentication, but a technology to acquire a broad dynamic range of the present invention is similarly very effective in not only authenticating the living body but also recognizing an object. For example, the technology is applicable to sensors having a purpose of image recognition, such as: an image recognition sensor of a robot for industry or amusement; an image recognition sensor for use in a car; a barcode or character recognition sensor; and a monitor camera.

### Second Embodiment

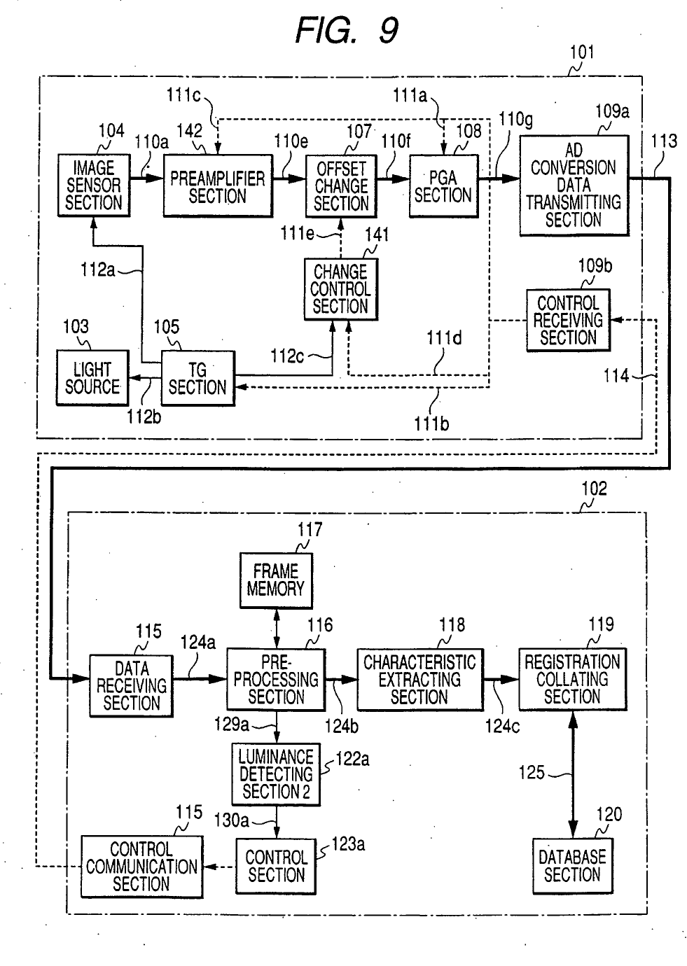

FIG. 9 is a block diagram of a schematic constitution of a sweeping (scanning) type fingerprint authentication device to which the present invention is applied as a second embodiment of the present invention. Here, as an example of a large difference of a luminance distribution in a plane of one living body image, there will be described a luminance difference generated by a positional relation between an optical system to illuminate an object and the object. There will be described an example in which environments are detected in the image sensor device, a control coefficient is selected depending on the environments, and one living body image is acquired while controlling offset, thereby improving a dynamic range.

In the present embodiment, the fingerprint authentication device is constituted of an image acquiring unit 101 and an authentication unit 102. The image acquiring unit is, for example, an image sensor unit having an image sensor, and the authentication unit is sometimes a combination of functions executed by a personal computer. Alternatively, the image acquiring unit and the authentication unit are combined as one fingerprint authentication unit to constitute an independent device to be connected to the personal computer (not shown) in some case.

In the image acquiring unit 101 of FIG. 9, reference numeral 103 denotes an LED as a light source (light irradiation means) for illumination.

Reference numeral 104 denotes a CMOS or CCD type image sensor section which is a one-dimensional sensor or a band-shaped two-dimensional sensor having about 5 to 20 pixels in a sub-scanning direction. In the present embodiment, the section is the CMOS type two-dimensional sensor having 512 pixels in a main scanning direction and 12 pixels in the sub-scanning direction.

Reference numeral 105 denotes a timing generating (TG) section which controls luminance levels and lighting timings of the image sensor section and the LED. Reference numeral 142 denotes a preamplifier section for amplifying an image pickup signal into a signal amplitude appropriate for subsequent-stage processing.

Reference numeral 107 denotes an offset change section capable of changing offset during image acquisition, and 108 denotes a programmable gain control amplifier (PGA) section which functions as a tone converting section for changing a gain of a signal whose DC component has been changed in a previous stage to convert tone.

Reference numeral 141 denotes a change control section which receives an instruction of a luminance detecting section in the authentication unit 102 to control the offset change section under control of the timing generating (TG) section.

Moreover, reference numeral 109a denotes an AD conversion and data transmitting section which AD-converts the signal subjected to tone conversion to transmit a data signal to the authentication unit, and 109 denotes a control receiving section which receives a control signal from the authentication unit.

Reference numeral 113 denotes a data signal line, and 114 denotes a control signal line.

Reference numerals 110a, 110e e, 110f, and 110g denote analog image data signal lines. Here, the analog signals are processed as such. The signals are appropriately amplified by the preamplifier section, and the extracted signal whose offset has been removed is further amplified by the PGA section to acquire an only part of the signal.

Reference numerals 111a, 111b, 111c, and 111d denote control lines which receive a control signal of the authentication unit 102 to control the PGA section, the timing generating (TG) section, the preamplifier section, and the change control section.

Reference numeral 111e denotes a control line via which the change control section 141 controls the offset change section 107.

Reference numerals 112a and 112b denote signal lines of drive pulses transmitted from the timing generating section to the image sensor section and the LED section. Reference numeral 112c denotes a control pulse line to the change control section, which sends a synchronous signal of the sub-scanning direction for changing the offset in synchronization with the signal of the sub-scanning direction.

In the authentication unit 102, reference numeral 115 denotes a control communication section.

Reference numeral 122a denotes a second luminance detecting section which calculates a luminance of a living body information area to detect a change of distribution of a quantity of light passing through an object. Reference numeral 123a denotes a control section which receives information of sections including the second luminance detecting section to control the image acquiring unit 101.

Reference numeral 116 denotes a preprocessing section which performs image processing such as edge emphasizing in order to extract characteristics in a subsequent stage. Reference numeral 117 denotes a frame memory section for performing the image processing. Reference numeral 118 denotes a characteristic extracting section, and 119 denotes a registration collating section which registers individual characteristics executed by the section 118 in a database or which compares and collates the characteristics with registered data. Reference numeral 120 denotes a database section which stores individual data.

Reference numerals 124a, b, and c denote data lines which transmit image data. Reference numeral 125 denotes a data line or a control line between the database and the registration collating section. Reference numeral 129a denotes a signal line which sends image information required for luminance detection, and 130a denotes a signal line which transmits a luminance detection result.

In the present embodiment, the second luminance detecting section 122a in the authentication unit 102 judges the environments from the image signal received by the image acquiring unit, and sets a gain of the PGA section 108 in the image acquiring unit 101. The change control section 141 changes the offset in the plane in accordance with the control of the authentication unit. In this case, the offset change section is controlled in accordance with the control pulse generated from the TG section 105 and synchronized with the scanning of the sub-scanning direction. An amount of the offset to be changed in the plane is calculated and determined from a detection result of the second luminance detecting section by the control section 123a in the authentication unit 102. As described later, the offset is dynamically changed so as to correct a longitudinal direction generated by a difference of transmittance of illuminative light passed through the object.

In the sweeping type sensor described in the present embodiment, to acquire a partially continuous image as described later, the offset is changed in synchronization with the sub-scanning direction in the image plane by acquiring the image while changing the offset to acquire each partial image. Accordingly, in the image sensor system, the distribution of the quantity of the light passed through the object is detected to acquire the partial image while controlling the offset depending on the quantity of the light passed through the object. Moreover, the image can be synthesized to acquire one living body image having an optimum contrast over the whole object.

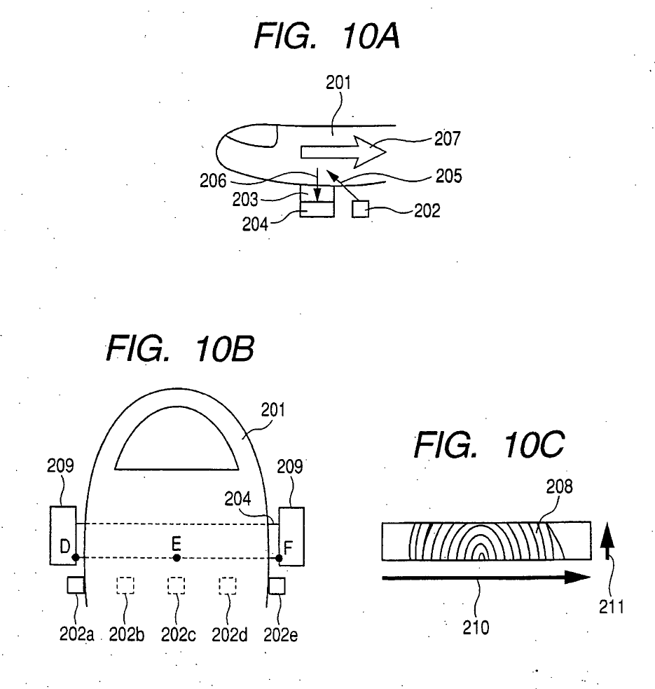

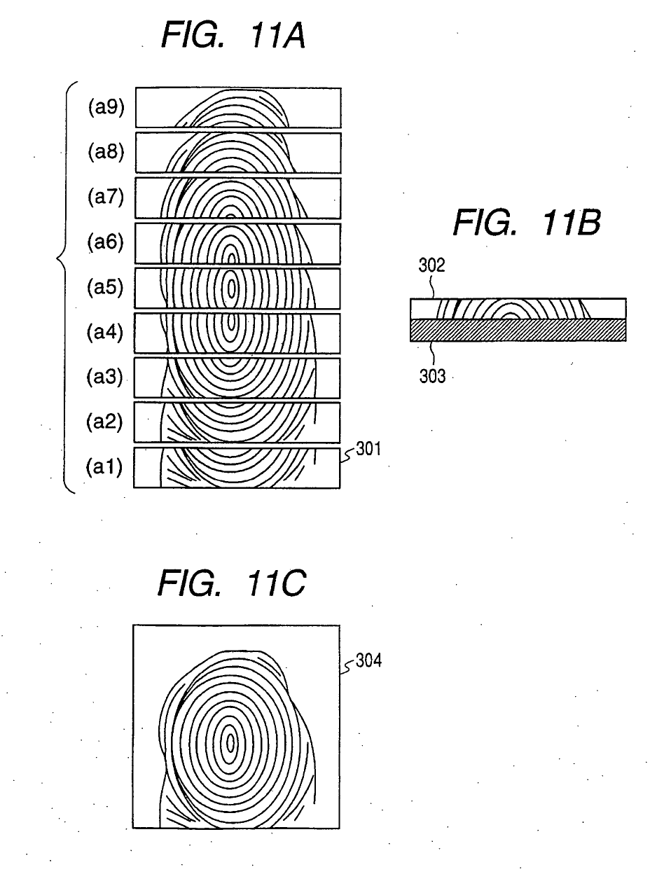

FIGS. 10A to 10C and 11A to 11C show explanatory views of an optical fingerprint sensor using a system referred to as a sweeping type in the present embodiment.

FIG. 10A is a diagram seen from the side of the finger, and FIG. 10B is a diagram seen from above the finger. FIG. 10C shows one fingerprint image acquired by the band-shaped two-dimensional sensor.

Reference numeral 201 denotes the finger, and 202 (202a to 202e) denotes LEDs as light sources. Reference numeral 203 denotes an optical member which guides an optical difference of an uneven pattern of a fingerprint to a sensor, and 204 denotes a one-dimensional sensor or a band-shaped two-dimensional sensor having about 5 to 20 pixels in the sub-scanning direction, and denotes a CMOS type image sensor element here.

Here, reference numeral 205 denotes an emission direction of light from the light source to the finger, and 206 denotes an incidence direction of light from the finger to the sensor. Reference numeral 207 denotes a moving (sweeping or scanning) direction of the finger.

Moreover, reference numeral 208 denotes a fingerprint pattern of one fingerprint image acquired by the band-shaped two-dimensional sensor.

Furthermore, reference numeral 209 denotes a guide mechanism which prevents the finger from being vibrated or displaced in the moving direction and a vertical direction during a moving operation of the finger. Points D, E, and F indicate positions of sensor pixels.

Here, reference numeral 210 denotes a main scanning direction of the sensor, and 211 denotes a sub-scanning direction of the sensor.

In the present embodiment, the LEDs which are the light sources are arranged in parallel with the main scanning direction.

There will be described synthesizing of an image of the whole fingerprint by use of images acquired by such sweeping type sensor with reference to FIGS. 11A to 11C. In the drawing, (a1) to (a9) show fingerprint partial images continuously acquired by the band-shaped two-dimensional sensor while moving the finger in the direction 207. FIG. 11B shows one image=one frame, and corresponds to (a6). Here, reference numeral 303 denotes the same finger area as that included in the image of (a5). FIG. 11C shows one fingerprint image obtained by synthesizing the partial images acquired by the band-shaped two-dimensional sensor.

As to the fingerprint partial images successively picked up and acquired in the sub-scanning direction while moving the finger along the sensor as shown in FIGS. 10A to 10C, areas having high correlation in the continuous image such as the area 303 are judged to be the same finger area whose image is picked up, and connected to one another. As a result, the whole image 304 of the fingerprint is re-constituted.

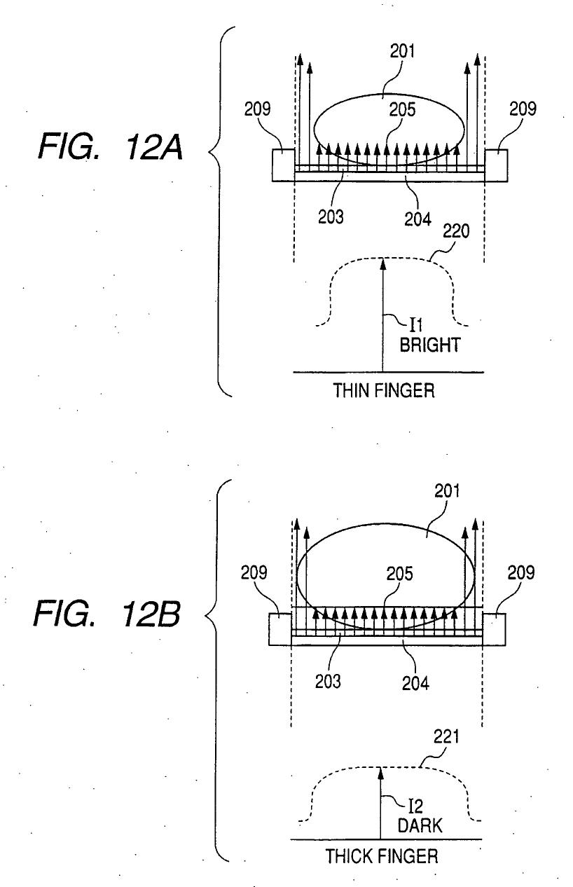

There will be described a difference of the luminance level owing to a difference of thickness of the finger which is an object with reference to FIGS. 12A to 12B. FIG. 12A shows a case where the finger is thin, and FIG. 12B shows a case where the finger is thick. Each luminance level of the illuminated finger is shown under the diagram viewed from a fingertip side. As shown in FIG. 12A, when the finger is thin, a luminance level 220 is obtained. The luminance level becomes high as shown by I1 in a central portion. On the other hand, as shown in FIG. 12B, when the finger is thick, a luminance level 221 is obtained. The luminance level lowers as shown by I2 in the central portion. This is because the thin finger more easily passes light 205 emitted from the LED in the finger, and intensity of light 206 emitted from the finger toward the sensor increases. As a result, the sensor output largely changes depending on not only an individual difference of the finger thickness but also the thickness of each portion of the same finger. The output is also influenced by the change of the finger thickness due to a finger pressing force or the like.

In the present embodiment, while the finger is moved, such luminance change with each finger portion is detected, and a group of partial images are acquired while changing the offset depending on the luminance change. The signal is adjusted into the dynamic range of the PGA section in the subsequent stage to thereby appropriately performing the tone conversion, and contrast of the fingerprint image is improved.

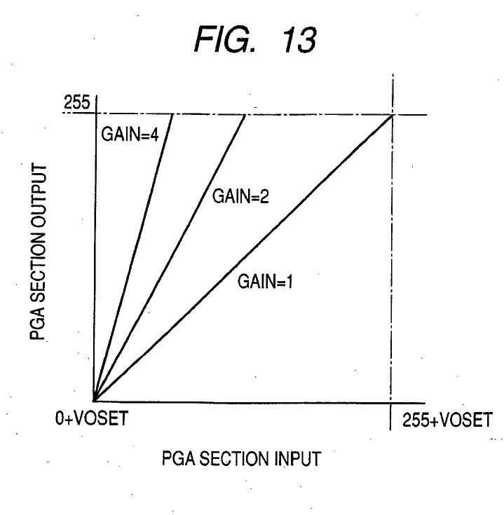

There will be described an operation of in-plane control of tone conversion characteristics by use of offset control in the present embodiment with reference to FIGS. 13 to 15.

FIG. 13 shows an example of a tone conversion curve for use in the PGA section. Here, there are shown characteristics in a case where one-fold, two-fold, and four-fold gains are applied. An output becomes constant at 255 with respect to an input which is not less than a saturated point. An input region depends on an offset value VOSET of a previous-stage offset circuit, and the output is converted into a value of 0 to 255 in a range of VOSET to 255+VOSET. A region which is not saturated at a gain value at that time in the range of VOSET to 255+VOSET is a region in which an output is obtained by emphasizing the input signal.

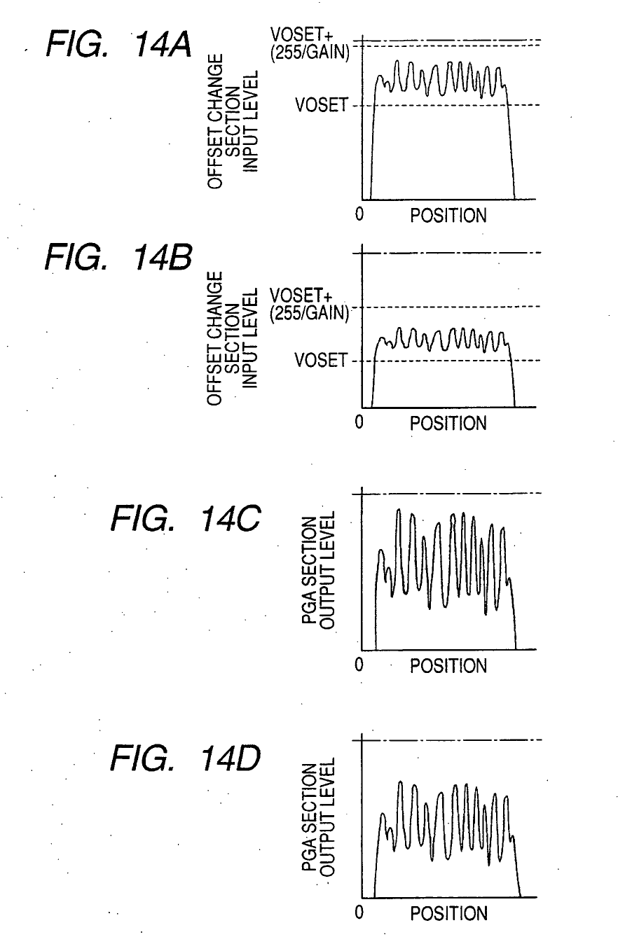

FIGS. 14A and 14B show signals between D and F, input into the offset change section. The abscissa indicates a cross-sectional direction position (between D and F) of the finger, and the ordinate indicates an input level of the offset change section. FIG. 14A shows a case where the finger is thin, and FIG. 14B shows a case where the finger is thick. Here, an input level in the tone converting section at a time when an offset amount VOSET is applied falls in a range of VOSET to VOSET+(255/GAIN). FIGS. 14C and 14D show output levels of the PGA section at a time when the offset amount VOSET is applied, and correspond to FIGS. 14A and 14B, respectively. The abscissa indicates positions of the finger in a cross-sectional direction (between D and F), and the ordinate indicates an output level of the PGA section.

The level is converted depending on the offset amount VOSET. For example, VOSET=255 is selected in the case where the finger is thin as shown in FIG. 14A, and VOSET=127 is selected in the case where the finger is thick as shown in FIG. 14B to thereby convert the level into the range of VOSET to VOSET+(255/GAIN). When the offset amount is changed in this manner to change the input region into the PGA section for each acquired partial image in order to optimize the contrast of the image of the whole finger, the dynamic range can be broadened.

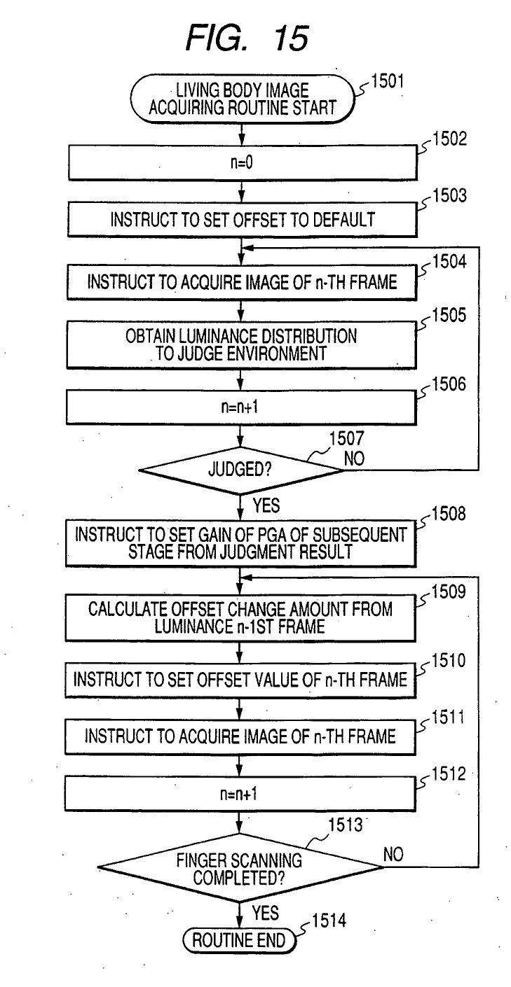

There will be described a control performed by the authentication unit 102 in the present embodiment with reference to a flowchart of FIG. 15. When the authentication unit starts a routine to acquire the image of the whole finger in step 1501, a control section sets the counted number of acquired frames of partial images to an initial value of 0 in 1502. In 1503, the image acquiring unit 101 is instructed to set an offset value to a default value. The partial image of one frame is acquired in 1504, and the luminance distribution included in the signal is obtained by the second luminance detecting section in 1505 to judge environments. In 1506, the control section increases the counted number of the acquired partial images by one frame. When the environments cannot be judged in the second luminance detecting section in 1507, the processing returns to 1504 to acquire the partial image of one frame and judge the environments again. In 1507, when the environments can be judged, the processing advances to 1508 in which the image acquiring unit 101 is instructed to set an appropriate gain value of the PGA section. In 1509, the offset change amount is similarly calculated from the result of the previous frame in the second luminance detecting section. The processing advances to 1501 to transmit the calculated offset value to the image acquiring unit 101. The unit is instructed to set the change amount. The instructed image acquiring unit receives the set value changed by the change control section, and controls the offset change section in synchronization with the image picking-up in the sub-scanning direction in response to a pulse received from the timing control (TG) section and indicating an interval between the partial images.

After the change, an image of an n-th frame is instructed to be acquired in 1511. In 1512, the control section increases the counted number of the frames by 1. It is judged in 1513 whether or not the scanning of the finger is completed (e.g., the completion of the scanning is judged by means of a luminance difference due to the presence of the finger). When the scanning is not completed, the processing returns to 1509 to acquire the next partial image. When the scanning is completed, the processing ends.

Consequently, even when the luminance or the contrast of the finger image largely changes with an object shape or size, a state change, and an environmental change, the tone conversion can be appropriately performed following the change. It is possible to acquire a high-quality image.

Moreover, the tone is not converted on the side of the authentication device until the image is acquired. Since the image is acquired while executing the tone conversion in the image acquiring device, the bit precision can be inhibited from being lowered in the preprocessing until the characteristics are extracted from the acquired image.

Furthermore, in the constitution of the present invention, the offset amount can be changed in the image plane to easily change the tone conversion characteristics in the image. Therefore, the emphasizing of the contrast of a certain specific portion such as a fingerprint ridge or a blood vessel in picking up the image can be realized with a simple circuit constitution and a small calculation amount. In this case, it is possible to pick up the whole image of the object while inhibiting a blackened or saturated region, and a broad dynamic range is realized.

Moreover, in the present embodiment, there has been described a system in which an object is collated (identified) by means of the fingerprint, but the present embodiment can be similarly used even in the system in which the object is collated (identified) by means of: hand or finger blood vessel; mug such as eye retina, iris, or face lines; hand shape or size and the like.

Especially, the sweeping sensor further has two advantages. First, the sweeping type sensor needs to acquire the partial image at a sufficiently high speed as compared with a finger moving speed, and in respect of such speed the constitution is advantageous in which the tone conversion is quickly performed by means of the simple calculation depending on the offset change. Secondly, when the partial images are connected to one another to re-constitute the image as described above, a correlation amount between the partial images raises a problem, but this correlation amount drops in a case where the tone conversion characteristics are largely changed with each partial image. In this respect, the offset control is suitable because the offset is easily changed by continuously and moderately changing the offset amount while keeping continuity of the image.

As a result, the setting can be changed in the first several partial images during one finger tracing operation. In addition, the tone conversion characteristics can be changed following a fluctuation of luminance due to the change of the finger thickness or the finger pressing pressure during the acquiring of the image. Consequently, the image quality is improved more than before, it is possible to prevent failure that a user has to trace the finger again owing to inappropriate image contrast or offset, and the fingerprint authentication device having high usability and high precision can be realized.

It is to be noted that the miniaturization of the processing circuit is suitable for a cellular phone, a portable personal computer, a portable device such as a personal data assistant (PDA) and the like for which portability is required.

Moreover, in the present embodiment, there has been described the system in which the object is collated (identified) by means of the fingerprint, but the present embodiment is similarly usable even in a system in which the object is collated (identified) by means of mug such as eye retina or face lines, hand shape or size and the like.

Furthermore, in the present embodiment, the image sensor device for living body authentication has been described, but the technology to acquire the broad dynamic range in the present invention is not limited to the living body authentication, and is similarly effective in recognizing an object. The technology is applicable to sensors having a purpose of image recognition, such as: an image recognition sensor of a robot for industry or amusement; an image recognition sensor for use in a car; a barcode or character recognition sensor; and a monitor camera.

This application claims priority from Japanese Patent Application No. 2005-047447 filed Feb. 23, 2005, which is hereby incorporated by reference herein.

What is claimed is:

1. A sweeping type image sensor device for authentication, which successively picks up images of partial image information of an object to obtain the whole image of the object, the image sensor device comprising: an image sensor element; a tone conversion unit, and a tone conversion characteristic changing unit,
the tone conversion unit having a variable gain amplifier,
the tone conversion characteristic changing unit having a constitution for changing reference level of an image signal so as to change tone conversion characteristics before completing all of tone conversion of the whole image.

2. The sweeping type image sensor device for authentication according to claim 1, wherein the tone conversion characteristic changing unit is disposed in a stage previous to that of the tone conversion unit.

3. The sweeping type image sensor device for authentication according to claim 1, wherein a luminance distribution of the image is detected to control the tone conversion characteristic changing unit,

4. The sweeping type image sensor device for authentication according to claim 1, wherein the tone conversion characteristics are changed in synchronization with a sub-scanning timing of the image sensor element.

5. The sweeping type image sensor device for authentication according to claim 1, wherein an offset is changed in synchronization with the acquiring of the partial image by the image sensor element to acquire the image.

6. A living body authentication system comprising:
the sweeping type image sensor device for authentication according to claim 1; and
a collation unit which collates an image signal from the image sensor device with registered information of the object acquired beforehand.

7. The living body authentication system according to claim 6, wherein the object is at least one of eye, face, hand and finger.

8. An authentication image acquiring method in a sweeping type image sensor device for authentication which successively picks up images of partial image information of an object to obtain the whole image of the object, the method comprising the steps of:
changing an offset amount and a gain of an arbitrary image signal during the picking-up of the whole image to pick up the image of the whole object.
